(19) United States
(12) Patent Application Publication
(10) Pub. No.: US 2020/0105180 A1
(43) Pub. Date: Apr. 2, 2020

(54) DISPLAY DEVICE AND DRIVING METHOD

(71) Applicant: SHANGHAI TIANMA MICRO-ELECTRONICS CO., LTD., Shanghai (CN)

(72) Inventors: Lei WANG, Shanghai (CN); Xiangjian KONG, Shanghai (CN); Mingwei ZHANG, Shanghai (CN); Dachao LIU, Shanghai (CN); Liang ZHOU, Shanghai (CN); Jine LIU, Shanghai (CN); Feng QIN, Shanghai (CN)

(21) Appl. No.: 16/213,445

(22) Filed: Dec. 7, 2018

(30) Foreign Application Priority Data
Sep. 27, 2018 (CN) 201811131083.2

(51) Int. Cl. G09G 3/20

(52) U.S. Cl. CPC G09G 3/2085; G09G 2320/10; G09G 2310/0254; G09G 2310/0224; G09G 2310/0229; G09G 2320/0247

(57) ABSTRACT

A driving method for a display device. The display device includes a display panel configured to display images and a driving chip configured to provide driving signals and data signals to the display panel. The driving method includes inputting initial image data; determining whether picture switching occurs; and in response to determining that picture switching occurs, using a progressive scanning mode to provide the driving signals to the display panel, and in response to determining that picture switching does not occur, using an interlaced scanning mode to provide the driving signals to the display panel.

### CROSS-REFERENCES TO RELATED APPLICATIONS

This application claims the priority of Chinese patent application No. 201811131083.2, filed on Sep. 27, 2018, the entirety of which is incorporated herein by reference.

### FIELD OF THE DISCLOSURE

The present disclosure generally relates to the field of display technology and, more particularly, relates to a display device and a driving method thereof.

### BACKGROUND

Currently, widely used display devices include, for example, mobile phones, computers, televisions, etc. The display devices are classified into cathode ray tube (CRT) display devices, liquid crystal display devices, plasma display devices, etc.

A display device typically includes an image processor, a display panel, and a signal controller. Generally, the image processor transmits image data to be displayed on the display panel to the signal controller, and the signal controller then generates a control signal for driving the display panel. The control signal together with the image data are transmitted to the display panel, and thus drive the display panel to display images.

The images displayed on the display panel are generally divided into static images and dynamic images. The display panel can display several frames per second, and when the image data included in these frames are the same, a static image is displayed. However, when the image data included in these frames are different, a dynamic image is displayed.

Generally, when the image displayed on the display panel is a static image or a dynamic image, the driving manners of the display panel are the same. When the displayed image is switched between a static image and a dynamic image, or when a dynamic image is displayed, during picture switching, the picture tearing phenomenon may very likely occur, and in the process of displaying a static image, the picture flickering phenomenon may very likely take place. As such, the visual experience of the user is greatly degraded.

The disclosed display device and driving method are directed to solve one or more problems set forth above and other problems in the art.

### BRIEF SUMMARY OF THE DISCLOSURE

One aspect of the present disclosure provides a driving method for a display device. The display device includes a display panel configured to display images and a driving chip configured to provide driving signals and data signals to the display panel. The driving method includes inputting initial image data; determining whether picture switching occurs; and in response to determining that picture switching occurs, using a progressive scanning mode to provide the driving signals to the display panel, and in response to determining that picture switching does not occur, using an interlaced scanning mode to provide the driving signals to the display panel.

Another aspect of the present disclosure provides a display device. The display device includes a display panel, a driving chip, a switching-determination module, and a process. The display panel is configured to display images. The driving chip is configured to provide driving signals and data signals to the display panel, and to input initial image data into the display panel. In response to receiving a signal indicating that picture switching occurs, a progressive scanning mode is used to provide the driving signals to the display panel, and in response to receiving a signal indicating that picture switching does not occur, an interlaced scanning mode is used to provide the driving signals to the display panel. The switching-determination module is configured to determine whether picture switching occurs, and when picture switching occurs, send the driving chip the signal indicating that picture switching occurs, and when picture switching does not occur, send the driving chip the signal indicating that picture switching does not occur. The processor is electrically connected to the driving chip and configured to provide the driving signals and the data signals to the driving chip.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic flowchart of an exemplary driving method for a display device according to some embodiments of the present disclosure;

FIG. 2 illustrates a schematic diagram of polarities of data signals corresponding to consecutive frames on a display panel when the display panel is driven in a progressive scanning mode according to some embodiments of the present disclosure;

FIG. 3 illustrates a schematic diagram of polarities of data signals corresponding to consecutive frames on a display panel when the display panel is driven in an interlaced scanning mode according to some embodiments of the present disclosure;

FIG. 4 illustrates a diagram of a corresponding relationship between a plurality of pixel-unit rows and a plurality of gate driving units included in a display panel according to some embodiments of the present disclosure;

FIG. 5 illustrates a timing diagram of output driving signals of gate driving units that are electrically connected to the plurality of pixel-unit rows shown in FIG. 4 according to some embodiments of the present disclosure;

FIG. 6 illustrates a diagram of a corresponding relationship between a plurality of pixel-unit rows and a plurality of gate driving units included in a display panel according to some embodiments of the present disclosure;

FIG. 7 illustrates a timing diagram of the output driving signals of the gate driving units that are electrically connected to the plurality of pixel-unit rows shown in FIG. 6 according to some embodiments of the present disclosure;

FIG. 8 illustrates a diagram of functional structures of a display device according to some embodiments of the present disclosure;

FIG. 9 illustrates a diagram of a connection relationship between a switching-determination module, a processor, and a driving chip in a display device according to some embodiments of the present disclosure;

FIG. 10 illustrates a schematic diagram of a determination process of a switching-determination module according to some embodiments of the present disclosure;

FIG. 11 illustrates a schematic structural diagram of a display panel in a display device according to some embodiments of the present disclosure;

FIG. 12 illustrates a diagram of a connection relationship of a plurality of gate driving units in a display panel according to some embodiments of the present disclosure;

FIG. 13 illustrates a timing diagram for driving a display panel in a progressive scanning mode according to some embodiments of the present disclosure;

FIG. 14 illustrates a timing diagram for driving a display panel in an interlaced scanning mode according to some embodiments of the present disclosure;

FIG. 15 illustrates a diagram of a connection relationship of a plurality of gate driving units in a display panel according to some embodiments of the present disclosure;

FIG. 16 illustrates a timing diagram for driving a display panel in a progressive scanning mode corresponding to the connection relationship shown in FIG. 15 according to some embodiments of the present disclosure; and

FIG. 17 illustrates a schematic diagram of a display device according to some embodiments of the present disclosure.

### DETAILED DESCRIPTION

Various exemplary embodiments of the present disclosure will now be described in detail with reference to the accompanying drawings. It should be noted that the relative arrangement of the components and steps, numerical expressions and numerical values set forth in the embodiments are not intended to limit the scope of the present disclosure. The following description of the at least one exemplary embodiment is merely illustrative, and by no means can be considered as limitations for the application or use of the present disclosure.

It should be noted that techniques, methods, and apparatuses known to those of ordinary skill in the relevant art may not be discussed in detail, but where appropriate, the techniques, methods, and apparatuses should be considered as part of the specification.

In all of the examples shown and discussed herein, any specific values should be considered as illustrative only and not as a limitation. Therefore, other examples of exemplary embodiments may have different values.

It should be noted that similar reference numbers and letters indicate similar items in subsequent figures, and therefore, once an item is defined in a figure, it is not required to be further discussed or defined in the subsequent figures.

A display device typically includes an image process unit, a display panel, and a signal controller. Usually, the image processor transmits image data to be displayed on the display panel to the signal controller, and the signal controller then generates a control signal for driving the display panel. The control signal together with the image data are transmitted to the display panel, and thus drive the display panel to display images.

The images displayed on the display panel are generally divided into static images and dynamic images. The display panel can display several frames per second, and when the image data included in these frames are the same, a static image is displayed. However, when the image data included in these frames are different, a dynamic image is displayed.

Usually, when the image displayed on the display panel is a static image or a dynamic image, the driving manners of the display panel are the same. When the displayed image is switched between a static image and a dynamic image, or when a dynamic image is displayed, during picture switching, the picture tearing phenomenon may very likely occur, and in the process of displaying a static image, the picture flickering phenomenon may very likely take place. As such, the visual experience of the user is greatly degraded.

The present disclosure provides a display device and a driving method for the display device. According to the disclosed display device and driving, the scanning mode is adjusted according to whether picture switching occurs or not. Therefore, the disclosed display device and driving method may not only be conducive to reducing the flickering phenomenon during picture display, but also be helpful to reduce the possibility for the picture tearing phenomenon to occur during picture switching. As such, the disclosed display device and driving method may improve the display quality of pictures.

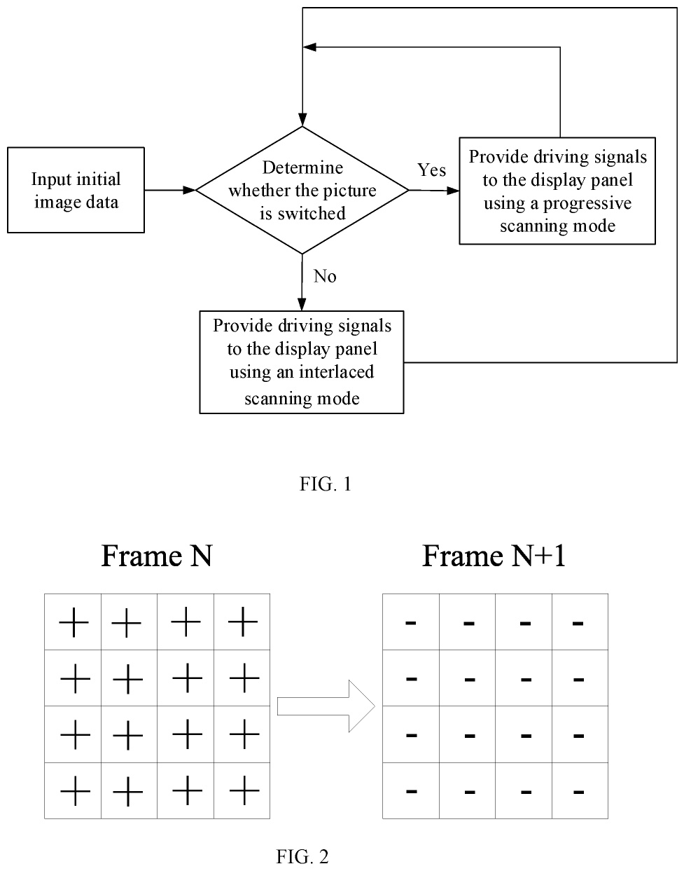

FIG. 1 illustrates a schematic flowchart of an exemplary driving method for a display device according to some embodiments of the present disclosure. Referring to FIG. 1, according to the driving method for the display device, the display device may include a display panel configured to display images, and a driving chip configured to provide driving signals and digital signals to the display panel. The driving method may include:
inputting initial image data;
determining whether picture switching occurs, and in response to determining that picture switching occurs, using a progressive scanning mode to provide the driving signals to the display panel; in response to determining that picture switching does not occur, using an interlaced scanning mode to provide the driving signals to the display panel.

It should be noted that the picture switching in the embodiments of the present disclosure may be, for example, switching between a static picture and a dynamic picture, or picture switching during a display process of a dynamic picture. How to determine whether picture switching occurs or not will be explained in detail later in the specification.

In the following, the progressive scanning mode and the interlaced scanning mode will be described in detail separately. FIG. 2 illustrates a schematic diagram of the polarities of data signals corresponding to consecutive frames on the display panel when the display panel is driven in a progressive scanning mode. A display panel usually includes a plurality of pixel-unit rows, and a progressive scanning mode is a scanning mode in which the plurality of pixel-unit rows are scanned in a row-by-row manner, for example, the plurality of pixel-unit rows are scanned from top to bottom, or the plurality of pixel-unit rows are scanned from bottom to top. In a same frame, the polarities of the data signals corresponding to the plurality of pixel-unit rows may be the same. In two consecutive frames, the polarities of the data signals corresponding to the plurality of pixel-unit rows may be changed. For example, referring to FIG. 2, in Frame N, the polarities of the data signals corresponding to the plurality of pixel-unit rows may all be positive; and in Frame N+1, the polarities of the data signals corresponding to the plurality of pixel-unit rows may all be changed to negative.

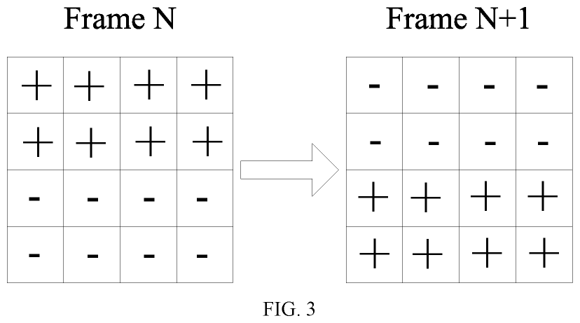

FIG. 3 illustrates a schematic diagram of the polarities of data signals corresponding to consecutive frames on the display panel when the display panel is driven in an interlaced scanning mode. In an interlaced scanning mode, the plurality of pixel-unit rows on the display panel may be divided into two groups that are alternately arranged, and during the scanning process, the pixel-unit rows in one of the two groups may be scanned first, and then the pixel-unit rows in the other group may be scanned. In a same frame, the polarities of the data signals corresponding to the pixel-unit rows in a same group may be the same, and the polarities of the data signals corresponding to the pixel-unit rows in different groups may be opposite to each other. That is, in a same frame, the polarities of the data signals corresponding to the plurality of pixel-unit rows may include both positive signs and negative signs. In the next frame, the polarity of the corresponding data signal of each pixel-unit row may be changed. For example, referring to FIG. 3, in Frame N, for the first and the second pixel-unit rows, which are included in a same group of the pixel-unit rows, the polarities of the corresponding data signals may be positive; and for the third and the fourth pixel-unit rows, which are included in another group of the pixel-unit rows, the polarities of the corresponding data signals may be negative. In Frame N+1, the polarities of the data signals corresponding to the first and the second pixel-unit rows may be changed to negative, while the polarities of the data signals corresponding to the third and the fourth pixel-unit rows may be changed to positive.

According to the disclosed driving method for display devices, during the process of displaying pictures on the display panel, when the displayed picture is switched, the display panel may be driven in a progressive scanning mode, and when the displayed picture is not switched, the display panel may be driven in an interlaced scanning mode. When picture switching occurs and the display panel is driven in the progressive scanning mode, the picture on the display panel may be refreshed in a row-by-row manner. Therefore, in a same frame, the polarities of the data signals corresponding to the plurality of pixel-unit rows may be the same, and thus the picture tearing phenomenon due to the difference in the polarities of the data signals in a same frame during the picture switching process may be greatly reduced. When picture switching does not occur and the display panel is driven in the interlaced scanning mode, the picture on the display panel may be refreshed in an interlaced manner. That is, the pixel-unit rows corresponding to pixel electrodes in one polarity may be refreshed first and the pixel-unit rows corresponding to pixel electrodes in the other polarity may then be refreshed. In a same frame, pixel-unit rows in different polarities may simultaneously display such that the positive and the negative polarities may cancel each other out, which may be conducive to eliminating the impact of the difference in the brightness of different polarities, and thus may be helpful to suppress the picture flickering phenomenon. Therefore, the disclosed driving method for display devices may be able to flexibly adjust the driving manner for the display panel according to whether picture switching occurs or not, and thus may be conducive to reducing the flickering phenomenon generated during the picture display process. In the meantime, the disclosed driving method may also be conducive to reducing the possibility for the picture tearing phenomenon to appear during the picture switching process. Therefore, the disclosed driving method for display devices may be beneficial to improving the display effect and the display quality of the picture, and thus may be conducive to improving the visual experience of the user.

In one embodiment, the initial image may be a static image, and correspondingly, according to the driving method for the display device, inputting the initial image data may further include inputting the initial image data and providing the display panel with driving signals using an interlaced scanning mode.

The images displayed on the display panel are generally divided into static images and dynamic images. The display panel can display several frames per second, and when the image data included in these frames are the same, a static image is displayed. However, when the image data included in these frames are different, a dynamic image is displayed. According to the disclosed driving method for display devices, when the initial image is a static image, e.g., picture switching does not occur, the display panel may be driven in an interlaced scanning mode. When driving the display panel in the interlaced scanning mode, in a same frame, the plurality of pixel-unit rows with different polarities may be simultaneously displayed, and the positive and the negative polarities may cancel each other out, which is beneficial to eliminating the influence of the difference in the brightness of different polarities. As such, the picture flickering phenomenon may be suppressed, and thus the display quality may be improved, which may also be beneficial to improving the visual experience of the user.

In one embodiment, the initial image may be a dynamic image, and correspondingly, according to the driving method for the display device, inputting the image data may further include inputting the initial image data and providing the display panel with driving signals using a progressive scanning mode.

According to the disclosed driving method for display devices, when the initial image is a dynamic image, the display panel may be driven in a progressive scanning mode as picture switching occurs in the display process of the dynamic image. When driving the display panel in the progressive scanning mode, the picture on the display panel may be refreshed in a row-by-row manner. In a same frame, the polarities of the data signals corresponding to the plurality of pixel-unit rows may be the same, and thus the picture tearing phenomenon due to the difference in the polarities of the data signals in a same frame during the picture switching process may be greatly reduced. As such, the display quality may be improved, which may also be beneficial to improving the visual experience of the user.

Further, in one embodiment, according to the disclosed driving method for display devices, determining whether picture switching occurs may include determining whether the data signals corresponding to the current frame are identical to the data signals corresponding to the previous frame. When the data signals corresponding to the current frame are identical to the data signals corresponding to the previous frame, it is determined that picture switching does not occur; and when the data signals corresponding to the current frame are not completely the same as, or are completely different from the data signals corresponding to the previous frame, it is determined that picture switching occurs.

When picture switching occurs, the data signals corresponding to two consecutive frames are different. Therefore, according to the disclosed driving method, by determining whether the data signals corresponding to two consecutive frames are the same, whether picture switching occurs can be determined. When the data signals corresponding to two consecutive frames are identical, the picture may not be switched, e.g., picture switching may not occur; and when the data signals corresponding to two consecutive frames are different, the picture may be switched, e.g., picture switching may occur. In one embodiment, a driving chip included in the display device may be configured to determine whether picture switching occurs. In other embodiments, any other appropriate building module included in the display device may be configured to determine whether picture switching occurs.

In one embodiment, the interlaced scanning mode according to the disclosed driving method for display devices may be a one-row-interlaced scanning mode, a two-row-interlaced scanning mode, or a multiple-row-interlaced scanning mode. For example, in the one-row-interlaced scanning mode, each time after a pixel-unit row, e.g., an even numbered row, is scanned, the scanning continues by skipping the next pixel-unit row, e.g., an odd numbered row, to scan the following pixel-unit, e.g., a following even numbered row. Similarly, in the two-row-interlaced scanning mode, each time after two consecutive pixel-unit rows are sequentially scanned, the scanning continues by skipping the next two pixel-unit rows; and in the multiple-row-interlaced scanning mode, each time after a certain number of consecutive pixel-unit rows are sequentially scanned, the scanning continues by skipping the same number of consecutive pixel-unit rows. The embodiments of the present disclosure are described mainly based on the one-row-interlaced scanning mode, although the interlaced scanning mode may be a two-row-interlaced scanning mode or a multiple-row-interlaced scanning mode.

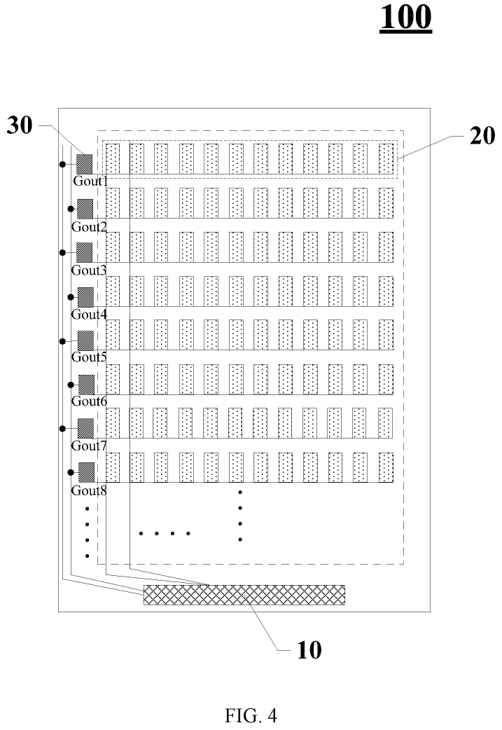

In one embodiment, the display panel of the display device may include a plurality of pixel-unit rows and a plurality of gate driving units. FIG. 4 illustrates a diagram of a corresponding relationship between a plurality of pixel-unit rows and a plurality of gate driving units included in a display panel according to some embodiments of the present disclosure. Referring to FIG. 4, the display panel 100 of the display device according to the present disclosure may include a plurality of pixel-unit rows 20 and a plurality of gate driving units 20. In the driving method for the display device, the one-row-interlaced scanning mode may include sequentially scanning the odd rows of the plurality of pixel-unit rows 20, and after completing the scan of all the odd rows, sequentially scanning the even rows of the plurality of pixel-unit rows 20, and then repeating the scanning cycle described above. When scanning the odd rows, the data signals applied to the odd rows may have a same polarity, and when scanning the even rows, the data signals applied to the even rows may have a same polarity. The polarity of the data signals corresponding to the odd rows may be different from the polarity of the data signals corresponding to the even rows.

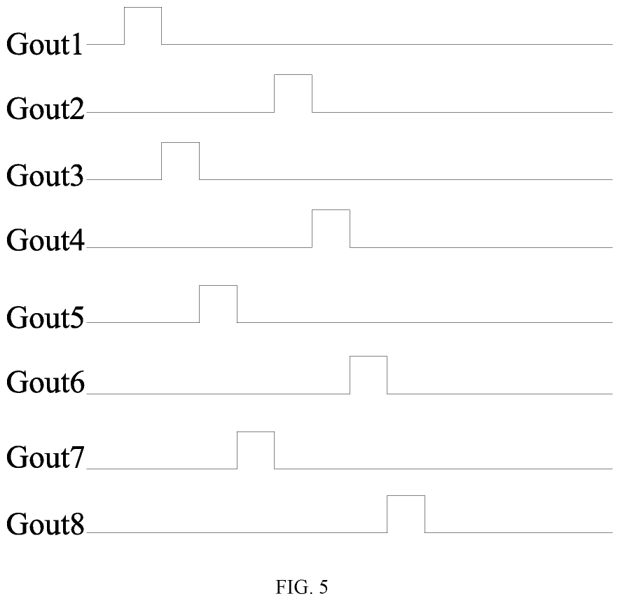

In one embodiment, when providing driving signals to the plurality of pixel-unit rows, the outputting driving signals from the driving chip 10 may be transmitted through the plurality of gate driving units 30 to the plurality of pixel-unit rows. FIG. 5 illustrates a timing diagram of the output driving signals of the gate driving units that are electrically connected to the plurality of pixel-unit rows shown in FIG. 4. Referring to FIG. 5, Gout1 represents the input driving signal for the first pixel-unit row, Gout2 represents the input driving signal for the second pixel-unit row, so on and so forth. It should be noted that in FIGS. 4-5, only a case where eight gate driving units correspond to eight pixel-unit rows is described as an example for illustration, and other cases may be performed in a same manner.

In one embodiment, the interlaced scanning mode is a one-row-interlaced scanning mode, and accordingly, when scanning driving is provided for each pixel-unit row, Gout1, Gout3, Gout5, and Gout7 may be sequentially outputted first, and then Gout2, Gout4, Gout6, and Gout8 may be sequentially outputted. That is, the first pixel-unit row, the third pixel-unit row, the fifth pixel-unit row, and the seventh pixel-unit row may be sequentially scanned first, and then the second pixel-unit row, the fourth pixel-unit row, the sixth pixel-unit row, and the eighth pixel-unit row may be sequentially scanned. In a same frame, when the input driving signals for the odd pixel-unit rows are positive, the input driving signals for the even pixel-unit rows may be negative; and when the input driving signals for the odd pixel-unit rows are negative, the input driving signals for the even pixel-unit rows may be positive. The interlaced scanning mode described above is especially suitable when picture switching does not occur. In a same frame, pixel-unit rows with different polarities may simultaneously display, and the positive and the negative polarities may cancel each other out, which is beneficial to eliminating the influence of the difference in the brightness of different polarities. As such, the picture flickering phenomenon may be suppressed.

Alternatively, in the disclosed driving method for the display device, the interlaced scanning mode may be a two-row-interlaced scanning mode. In the following, illustration will be provided using the two-row-interlaced scanning mode as an example.

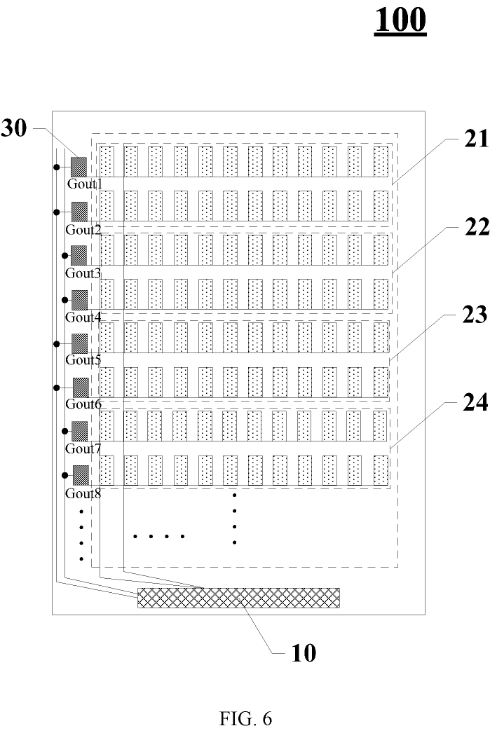

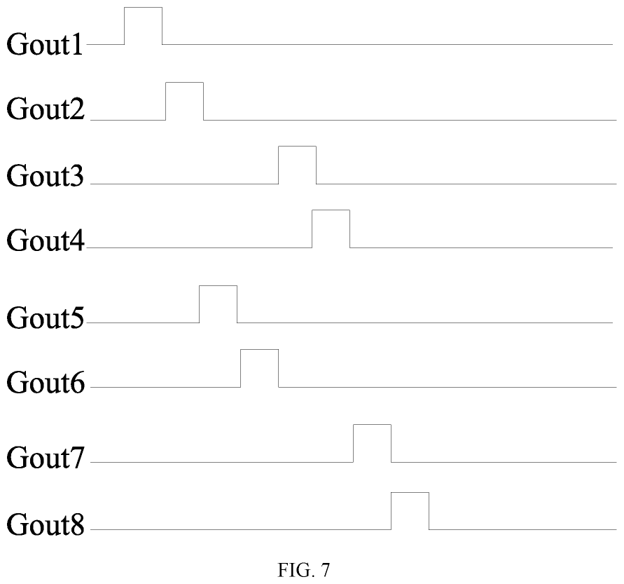

FIG. 6 illustrates a diagram of the corresponding relationship between a plurality of pixel-unit rows and a plurality of gate driving units included in a display panel 100 according to some embodiments of the present disclosure. FIG. 7 illustrates a timing diagram of the output driving signals of the gate driving units that are electrically connected to the plurality of pixel-unit rows shown in FIG. 6. Referring to FIGS. 6-7, the display panel 100 may include multiple pixel-unit rows, and the multiple pixel-unit rows may be divided into a plurality of pixel-unit-row groups with each group including two adjacent pixel-unit rows. Accordingly, the two-row-interlaced scanning mode may further include sequentially scanning the odd groups of the plurality of pixel-unit-row groups, and after completing the scan of all odd groups, sequentially scanning the even groups of the plurality of pixel-unit-row groups, and then repeating the scanning cycle described above. When scanning the odd groups, the data signals applied to the rows in the odd groups may have a same polarity, and when scanning the even groups, the data signals applied to the rows in the even groups may have a same polarity. The polarity of the data signals corresponding to the odd groups may be different from the polarity of the data signals corresponding to the even groups.

Referring to FIGS. 6-7, only a case where the display panel includes 8 pixel-unit rows is described as an example for illustration, and other cases may have a same manner. In FIG. 7, Gout1 represents the driving signal for the first pixel-unit row, Gout2 represents the input driving signal for the second pixel-unit row, so on and so forth. The pixel-unit rows may be divided into a plurality of pixel-unit-row groups. In one embodiment, referring to FIG. 6, the display panel may include four pixel-unit-row groups, e.g., a first pixel-unit-row group 21, a second pixel-unit-row group 22, a third pixel-unit-row group 23, and a fourth pixel-unit-row group 24, and each pixel-unit-row group may include two pixel-unit rows. For example, the first pixel-unit-row group 21 may include the first pixel-unit row and the second pixel-unit row, the second pixel-unit-row group 22 may include the third pixel-unit row and the fourth pixel-unit row, the third pixel-unit-row group 23 may include the fifth pixel-unit row and the sixth pixel-unit row, and the fourth pixel-unit-row group 24 may include the seventh pixel-unit row and the eighth pixel-unit row. Referring to FIG. 7, in the process of scanning the plurality of pixel-unit rows, the odd groups among the pixel-unit-row groups (e.g., the first pixel-unit-row group 21 and the third pixel-unit-row group 23) may be sequentially scanned, and then the even groups (e.g., the second pixel-unit-row group 22 and the fourth pixel-unit-row group 24) may be sequentially scanned. For example, Gout1, Gout2, Gout5, and Gout6 may be sequentially outputted first, and then Gout3, Gout4, Gout7, and Gout8 may be sequentially outputted. That is, the first pixel-unit row, the second pixel-unit row, the fifth pixel-unit row, and the sixth pixel-unit row may be sequentially scanned first, and then the third pixel-unit row, the fourth pixel-unit row, the seventh pixel-unit row, and the eighth pixel-unit row may be sequentially scanned. As such, the two-row-interlaced scanning mode may be implemented. When driving the display panel in the interlaced scanning mode, in a same frame, pixel-unit rows with different polarities may simultaneously display, and thus the positive and the negative polarities may cancel each other out, which is beneficial to eliminating the influence of the difference in the brightness of different polarities. As such, the picture flickering phenomenon may be suppressed.

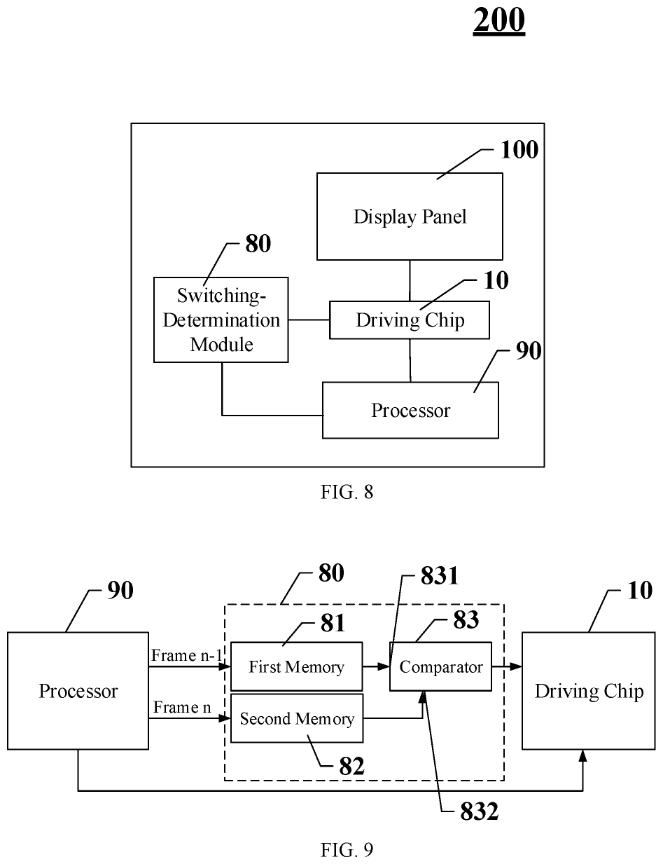

Accordingly, the present disclosure also provides a display device. FIG. 8 illustrates a diagram of the functional structures of a display device 200 according to some embodiments of the present disclosure. Referring to FIG. 8, the display device 200 may include a display panel 100 configured to display images, and a driving chip 10 configured to provide driving signals and digital signals to the display panel 100. The driving chip 10 may also be configured to input initial image data into the display panel 100. In response to receiving a signal indicating that picture switching occurs, a progressive scanning mode may be used to provide the driving signals to the display panel; and in response to receiving a signal indicating that picture switching does not occur, an interlaced scanning mode may be used to provide the driving signals to the display panel.

The display device may also include a switching-determination module 80. The switching-determination module 80 may be configured to determine whether picture switching occurs. Moreover, when picture switching occurs, the switching-determination module 80 may send a signal, indicating that picture switching occurs, to the driving chip 10; and when picture switching does not occur, the switching-determination module 80 may send a signal, indicating that picture switching does not occur, to the driving chip 10.

The display device may further include a processor 90, electrically connected to the driving chip 10 and configured to provide driving signals and data signals to the driving chip 10.

Referring to FIG. 8, a switching-determination module 80 may be introduced into the disclosed display device 200. The switching-determination module 80 may be able to determine whether picture switching occurs during the picture display process of the display panel 100, and after the switching-determination module 80 sends the determination result to the driving chip 10, the driving chip 10 may select a driving mode according to the determination result to drive the display panel 100. In the disclosed display device 200, during the picture display process of the display panel 100, when picture switching occurs, the driving chip 10 may use a progressive scanning mode to drive the display panel 100; and when picture switching does not occur, the driving chip 10 may use an interlaced scanning mode to drive the display panel 100.

When the picture switching occurs and the progressive scanning mode is used to drive the display panel 100, the picture on the display panel may be refreshed in a row-by-row manner. Therefore, in a same frame, the polarities of the data signals corresponding to the plurality of pixel-unit rows may be the same, and thus the picture tearing phenomenon due to the difference in the polarities of the data signals in a same frame during the picture switching process may be greatly reduced. When the picture switching does not occur and the interlaced scanning mode is used to drive the display panel 100, the picture on the display panel may be refreshed in an interlaced manner. That is, the pixel-unit rows corresponding to pixel electrodes in a same polarity may be refreshed first and the pixel-unit rows corresponding to pixel electrodes in the other polarity may then be refreshed. In a same frame, pixel-unit rows in different polarities may simultaneously display such that the positive and the negative polarities may cancel each other out, which may be conducive to eliminating the impact of the difference in the brightness of different polarities, and thus may be helpful to suppress the picture flickering phenomenon. Therefore, the disclosed display device 200 may be able to flexibly adjust the driving manner for the display panel according to whether picture switching occurs or not, and thus may be conducive to reducing the flickering phenomenon generated during the picture display process. In the meantime, the disclosed display device 200 may also be conducive to reducing the possibility for the picture tearing phenomenon to appear during the picture switching process. Therefore, the disclosed display device 200 may be beneficial to improving the display effect of the picture.

FIG. 9 illustrates a diagram of the connection relationship between a switching-determination module, a processor, and a driving chip in a display device according to some embodiments of the present disclosure. Referring to FIG. 9, in one embodiment, the disclosed display device 200 may include a switching-determination module 80, a processor 90, and a driving chip 10. The switching-determination module 80 may further include a first memory 81, a second memory 82, and a comparator 83. The connection relationship between the switching-determination module 80, the processor 90, and the driving chip is schematically illustrated in FIG. 9.

The input terminal of the first memory 81 may be connected to the processor 90, and configured to receive the display data sent from the processor 90 for an (n−1)th frame; and the input terminal of the second memory 82 may be connected to the processor 90, and may be configured to receive the display data sent from the processor 90 for an nth frame, where n>1. The output terminal of the first memory 81 may be connected to the first input terminal 831 of the comparator 83, and the output terminal of the second memory 82 may be connected to the second input terminal 832 of the comparator 83. The output terminal of the comparator 83 may be connected to the driving chip 10, and configured to send signals indicating whether picture switching occurs or not to the driving chip 10.

Referring to FIG. 9, the processor 90 may send the display data for two consecutive frames (e.g., Frame n−1 and Frame n) to the first memory 81 and the second memory 82, respectively. The first memory 81 and the second memory 82 may further send Frame n−1 and Frame n to the two input terminals of the comparator 83. The comparator 83 may compare the display data Frame n−1 and Frame n. When the display data (e.g., Frame n−1 and Frame n) are the same, it means that picture switching does not occur, and thus a signal indicating that picture switching does not occur may be sent to the driving chip 10. When the display data (e.g., Frame n−1 and Frame n) are not the same, it means that picture switching occurs, and thus a signal indicating that picture switching occurs may be sent to the driving chip 10. As such, the switching-determination module 80 may be used for determining whether picture switching occurs or not. It should be noted that the comparator 83 according to the present disclosure may be built by using an operational amplifier, for example, an LM324 comparator or any appropriate comparator, and the memories (e.g., the first memory 81 and the second memory 82) may be any appropriate memories including conventional memories known in the field.

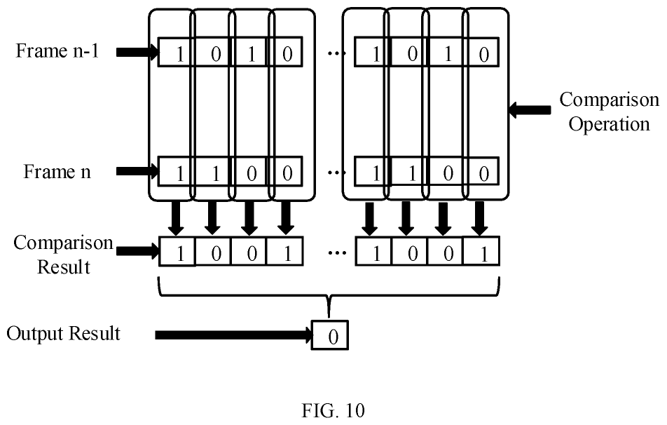

FIG. 10 illustrates a schematic diagram of a determination process of a switching-determination module according to some embodiments of the present disclosure. In one embodiment, the determination process of the display device 200 shown in FIG. 9 may be consistent with the illustration in FIG. 10. Referring to FIGS. 9-10, the first memory 81 may send the display data for Frame n−1 to the comparator 83 and the second memory 82 may also send the display data for Frame n to the comparator 83. The comparator 83 may perform comparison operations to compare the corresponding data in Frame n−1 and in Frame n in a byte-to-byte manner. As shown in FIG. 10, when a data byte in Frame n−1 is identical to the corresponding data byte in Frame n (for example, both are 1, or both are 0), the comparison result may be 1, otherwise the comparison result may be 0. For the final result to be outputted by the comparator 83 (referring to FIG. 9), when any position of the comparison results described above is 0, the output result may be 0, indicating that the display data for the two frames are different; however, when every position of the comparison results described above is 1, the output result may be 1, indicating that the display data are identical for the two frames. It should be noted that in one embodiment, a case where the output result is 0 is provided as an example in FIG. 10 for illustration, and in other embodiments, when all the comparison results are 1, the output result may be 1.

In one embodiment, the switching-determination module 80 may be integrated with the driving chip 10 in the disclosed display device 200. That is, the switching determination function performed by the switching-determination module 80 may be integrated into the driving chip 10. In an actual displaying process, the driving chip 10 itself may be able to determine whether picture switching occurs or not, and may also be able to drive the display panel 100 in different modes according to whether picture switching occurs. In addition, the method of integrating the switching-determination module 80 with the driving chip 10 may also be conducive to improving the efficiency of space-utilization of the display device 200.

In one embodiment, in the disclosed display device 200, the switching-determination module 80 may be integrated with the processor to form a signal piece. That is, the switching determination function performed by the switching-determination module 80 may be integrated into the driving chip 10. In the display device 200, the driving chip 10 is usually integrated onto the display panel 100, and the processor 90 is usually independent from the display panel 100. According to the present disclosure, integrating the switching determination module 80 into the processor 90 may be conducive to improving the efficiency of space-utilization of the display device 200, and in the meantime, may be conducive to simplifying the function structure of the driving chip 10, and improving the production rate of the display panel 200.

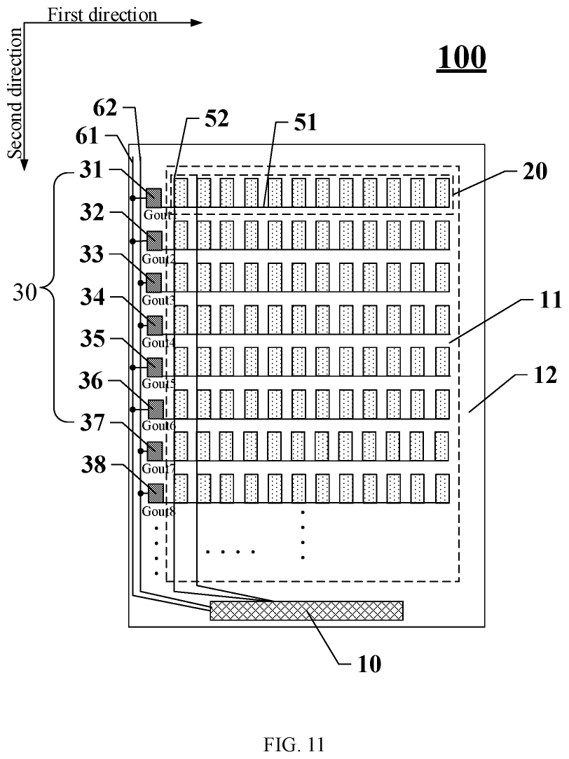

FIG. 11 illustrates a schematic structural diagram of a display panel in a display device according to some embodiments of the present disclosure. Referring to FIG. 11, the display device may include a display panel 100. The display device may have a display region 11 and a non-display region 12 surrounding the display region. The display panel may include a plurality of gate lines 51 extending along a first direction and arranged in a second direction, and a plurality of data lines 52 extending along the second direction and arranged in the first direction. The display panel 100 may also include a plurality of sub-pixel units defined by the intersection of the gate lines 51 and the data lines 52. The plurality of sub-pixel units may be located in the display region, and the plurality of sub-pixel units may form a plurality of pixel-unit rows.

The driving chip 10 may provide driving signals to each pixel-unit row through a corresponding gate line 51, and may provide data signals to each pixel-unit row through a corresponding data line 52.

In one embodiment, referring to FIG. 11, the display panel 100 may also include a gate driving circuit located in the non-display region. The gate driving circuit may include a plurality of gate driving units 30, a first driving-signal line 61, and a second driving-signal line 62.

The plurality of gate driving units 30 may be electrically connected to the plurality of gate lines 51 in one-to-one correspondence. Each gate driving unit 30 may include a plurality of first gate driving units (for example, including a gate driving unit 31, a gate driving unit 32, a gate driving unit 35, and a gate driving unit 36) and a plurality of second gate driving units (for example, including a gate driving unit 33, a gate driving unit 34, a gate driving unit 37, and a gate driving unit 38). The pixel-unit rows electrically connected to the first gate driving units and the pixel-unit rows electrically connected to the second gate driving units may be alternately arranged. The first gate driving unit may also be electrically connected to the first driving-signal line 61, and the second gate driving unit may also be electrically connected to the second driving-signal line 62.

The driving chip may sequentially provide driving signals to the plurality of pixel-unit rows through the first driving-signal line 61 or the second driving-signal line 62, the plurality of gate driving units 30, and the plurality of gate lines 51.

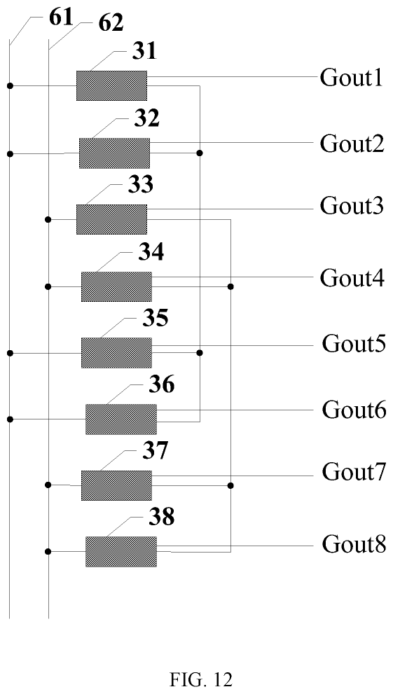

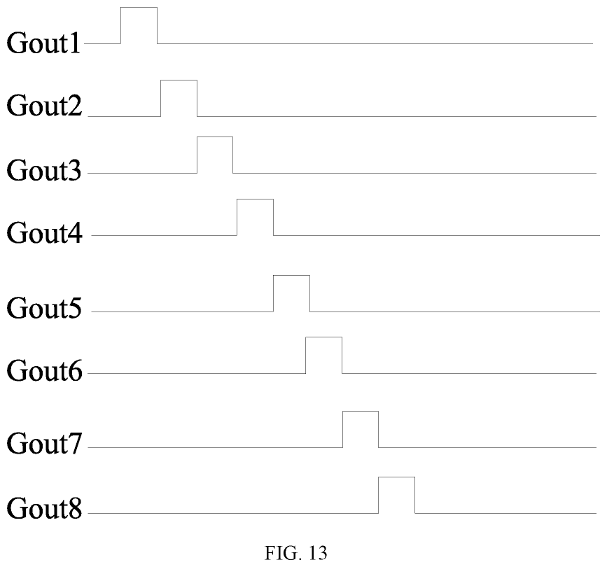

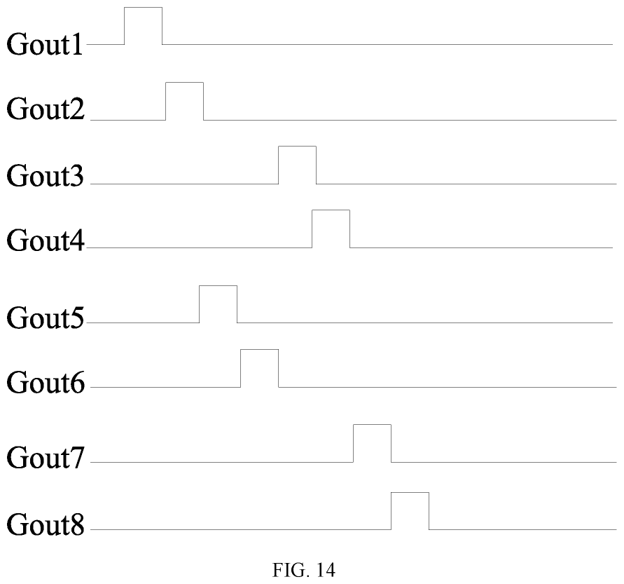

FIG. 12 illustrates a diagram of the connection relationship of a plurality of gate driving units in a display panel according to some embodiments of the present disclosure, FIG. 13 illustrates a timing diagram for driving the display panel in a progressive scanning mode, and FIG. 14 illustrates a timing diagram for driving the display panel in an interlaced scanning mode. In one embodiment, referring to FIG. 12, the gate driving units 31, 32, 35, and 36 are first gate driving units connected to the first driving-signal line 61, the gate driving units 33, 34, 37, and 38 are second gate driving units connected to the second driving-signal line 62. Gout1 represents the driving signal send from the gate driving unit 31 to the connected corresponding pixel-unit row, Gout2 Gout1 represents the driving signal send from the gate driving unit 32 to the connected corresponding pixel-unit row, and so on so forth. During the display process, when picture switching occurs, a progressive scanning mode may be adopted to drive the display panel 100. FIG. 13 illustrates the corresponding timing diagram. During the scanning process, Gout1, Gout2, Gout3, Gout4, Gout5, Gout6, Gout7, and Gout8 may be sequentially outputted. When picture switching does not occur, an interlaced scanning mode may be adopted to drive the display panel 100. FIG. 14 illustrates the corresponding timing diagram. During the scanning process, Gout1, Gout2, Gout5, Gout6, Gout3, Gout4, Gout7, and Gout8 may be sequentially outputted. It should be noted that in FIGS. 12-14, a display panel including only eight pixel-unit rows is provided as an example for illustration, and in the actual applications, driving more pixel-unit rows may be performed as the driving modes described above.

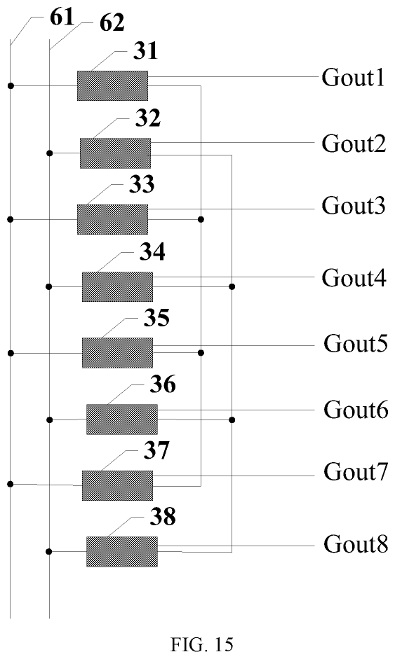

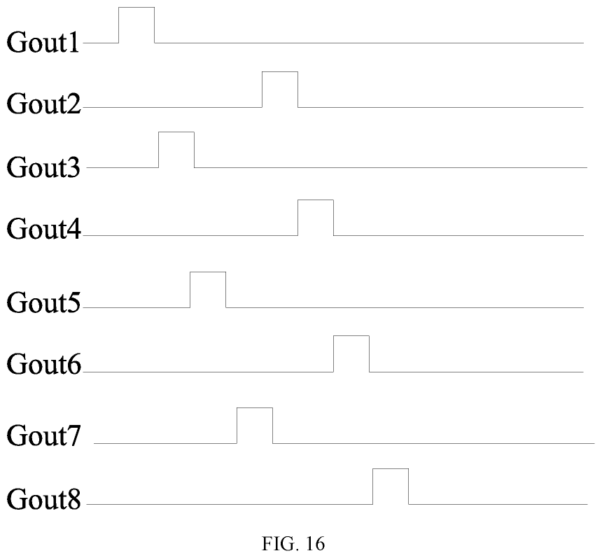

FIG. 15 illustrates a diagram of the connection relationship of a plurality of gate driving units in a display panel according to some embodiments of the present disclosure. FIG. 16 illustrates a timing diagram for driving a display panel in a progressive scanning mode corresponding to the connection relationship shown in FIG. 15. Referring to FIGS. 15-16, the display panel 100 may include a plurality of pixel-unit rows. The odd rows of the plurality of pixel-unit rows may be electrically connected to a plurality of first gate driving units, and the even rows of the plurality of pixel-unit rows may be electrically connected to a plurality of second gate driving units. In one embodiment, the plurality of first gate driving units may include gate driving units 31, 33, 35, and 37, and may be connected to the first driving-signal line 61; and the plurality of second gate driving units may include gate driving units 32, 34, 36, and 38, and may be connected to the second driving-signal line 62. When the plurality of pixel-unit rows and the plurality of gate driving units adopt such a connection manner, when the display panel 100 is driven in an interlaced scanning mode, the interlaced scanning mode may be a one-row-interlaced scanning mode. During the display process, when picture switching occurs, a progressive scanning mode may be adopted to drive the display panel 100, and the timing diagram of the progressive scanning mode may be referred to FIG. 13. That is, during the scanning process, Gout1, Gout2, Gout3, Gout4, Gout5, Gout6, Gout7, and Gout8 may be sequentially outputted. When picture switching does not occur, an interlaced scanning mode may be adopted to drive the display panel 100, and the timing diagram of the interlaced scanning mode may be referred to FIG. 16. That is, during the scanning process, Gout1, Gout3, Gout5, Gout7, Gout2, Gout4, Gout6, and Gout8 may be sequentially outputted. It should be noted that in FIGS. 15-16, a display panel including only eight pixel-unit rows is provided as an example for illustration, and in the actual applications, driving more pixel-unit rows may be performed as the driving modes described above.

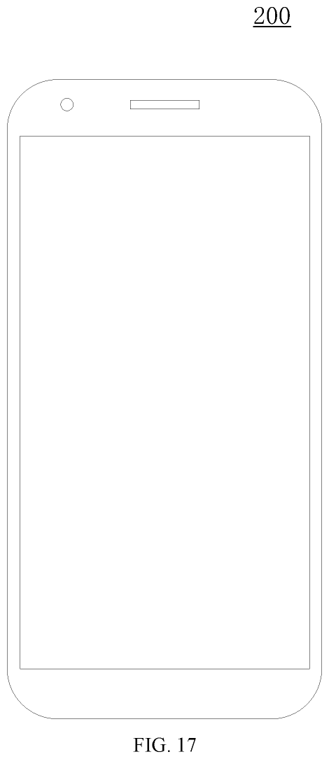

FIG. 17 illustrates a schematic diagram of a display device according to some embodiments of the present disclosure. Referring to FIG. 17, in one embodiment, the display device 200 according to the present disclosure may be a mobile phone. It should be noted that the disclosed display device may be any product or component having a display function, such as a mobile phone, a tablet computer, a television, a monitor, a notebook computer, a digital photo frame, a navigator, etc.

Compared to existing display devices and driving methods, the disclosed display device and driving method for the display device may demonstrate the following advantages.

According to the disclosed display device and driving method, the display device includes a display panel configured to display images and a driving chip configured to provide driving signals and data signals to the display panel. During the process of displaying pictures on the display panel, when the displayed picture is switched, the display panel is driven in a progressive scanning mode, and when the displayed picture is not switched, the display panel is driven in an interlaced scanning mode. When picture switching occurs and the display panel is driven in the progressive scanning mode, the picture on the display panel is refreshed in a row-by-row manner. Therefore, in a same frame, the polarities of the data signals corresponding to the plurality of pixel-unit rows are the same, and thus the picture tearing phenomenon due to the difference in the polarities of the data signals in a same frame during the picture switching process is greatly reduced. When picture switching does not occur and the display panel is driven in the interlaced scanning mode, the picture on the display panel is refreshed in an interlaced manner. That is, the pixel-unit rows corresponding to pixel electrodes in one polarity are refreshed first and then the pixel-unit rows corresponding to pixel electrodes in the other polarity are refreshed. In a same frame, pixel-unit rows in different polarities are simultaneously display such that the positive and the negative polarities may cancel each other out, which may be conducive to eliminating the impact of the difference in the brightness of different polarities, and thus may be helpful to suppress the picture flickering phenomenon. Therefore, the disclosed display device and driving method are able to flexibly adjust the driving manner for the display panel according to whether picture switching occurs or not, and thus the disclosed display device and driving method may be conducive to reducing the flickering phenomenon generated during the picture display process. In the meantime, the disclosed display device and driving method may also be conducive to reducing the possibility for the picture tearing phenomenon to appear during the picture switching process. Therefore, the disclosed display device and driving method may be beneficial to improving the display effect and the display quality of the picture.

The above detailed descriptions only illustrate certain exemplary embodiments of the present disclosure, and are not intended to limit the scope of the present disclosure. Those skilled in the art can understand the specification as whole and technical features in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. A driving method for a display device, wherein the display device includes a display panel configured to display images and a driving chip configured to provide driving signals and data signals to the display panel, the driving method comprising:
inputting initial image data;
determining whether picture switching occurs, and
in response to determining that picture switching occurs, using a progressive scanning mode to provide the driving signals to the display panel, and in response to determining that picture switching does not occur, using an interlaced scanning mode to provide the driving signals to the display panel.

2. The method according to claim 1, wherein the initial image data is a static image, and inputting the initial image data includes:
inputting the initial image data, and
using the interlaced scanning mode to provide the driving signals to the display panel.

3. The method according to claim 1, wherein the initial image data is a dynamic image, and inputting the initial image data includes:
inputting the initial image data, and
using the progressive scanning mode to provide the driving signals to the display panel.

4. The method according to claim 1, wherein determining whether picture switching occurs includes:
determining whether the data signals corresponding to a current frame are identical to the data signals corresponding to a previous frame adjacent to the current frame, and
in response to the data signals corresponding to the current frame being identical to the data signals corresponding to the previous frame, determining that picture switching does not occur, and
in response to the data signals corresponding to the current frame not being identical to or completely different from the data signals corresponding to the previous frame, determining that picture switching occurs.

5. The method according to claim 1, wherein:
the interlaced scanning mode includes a one-row-interlaced scanning mode.

6. The method according to claim 5, wherein the display panel includes a plurality of pixel-unit rows, and the one-row-interlaced scanning mode includes:
sequentially scanning odd rows of the plurality of pixel-unit rows;
after the odd rows are all scanned, sequentially scanning even rows of the plurality of pixel-unit rows; and
repeating the sequentially scanning the odd rows followed by the sequentially scanning the even rows, wherein:
when scanning the odd rows, the data signals applied to the odd rows have a same polarity;
when scanning the even rows, the data signals applied to the even rows have a same polarity; and
the polarity of the data signals applied to the odd rows is different from the polarity of the data signals applied to the even rows.

7. The method according to claim 1, wherein:
the interlaced scanning mode includes a two-row-interlaced scanning mode.

8. The method according to claim 7, wherein the display panel includes a plurality of pixel-unit rows, the plurality of pixel-unit rows are divided into a plurality of pixel-unit-row groups with each group including two adjacent pixel-unit rows, and the two-row-interlaced scanning mode includes:
sequentially scanning odd groups of the plurality of pixel-unit-row groups;
after the odd groups are all scanned, sequentially scanning even groups of the plurality of pixel-unit-row groups; and
repeating the sequentially scanning the odd groups followed by the sequentially scanning the even groups, wherein:
when scanning the odd groups, the data signals applied to the odd groups have a same polarity;
when scanning the even groups, the data signals applied to the even groups have a same polarity; and
the polarity of the data signals applied to the odd groups is different from the polarity of the data signals applied to the even groups.

9. The method according to claim 1, wherein the progressive scanning mode includes:
sequentially scanning the plurality of pixel-unit rows from top to bottom or from bottom to top, wherein:
in a same frame, the data signals applied to the plurality of pixel-unit rows have a same polarity; and
in two consecutive frames, a polarity of the data signals applied to the plurality of pixel-unit rows in a former frame is different from a polarity of the data signals applied to the plurality of pixel-unit rows in a latter frame.

10. A display device, comprising:
a display panel, configured to display images;
a driving chip, configured to provide driving signals and data signals to the display panel, and to input initial image data into the display panel, wherein:
in response to receiving a signal indicating that picture switching occurs, a progressive scanning mode is used to provide the driving signals to the display panel, and
in response to receiving a signal indicating that picture switching does not occur, an interlaced scanning mode is used to provide the driving signals to the display panel;
a switching-determination module, configured to determine whether picture switching occurs, and when picture switching occurs, send the driving chip the signal indicating that picture switching occurs, and when picture switching does not occur, send the driving chip the signal indicating that picture switching does not occur; and
a processor, electrically connected to the driving chip and configured to provide the driving signals and the data signals to the driving chip.

11. The device according to claim 10, wherein the switching-determination module further includes a first memory, a second memory, and a comparator, wherein:
an input terminal of the first memory is connected to the processor, an output terminal of the first memory is connected to a first input terminal of the comparator, and the first memory is configured to receive display data for a (n−1)th frame sent from the processor, where n>1;
an input terminal of the second memory is connected to the processor, an output terminal of the second memory is connected to a second input terminal of the comparator, and the second memory is configured to receive display data for an nth frame sent from the processor; and
an output terminal of the comparator is connected to the driving chip, and is configured to send signals indicating whether picture switching occurs or not to the driving chip.

12. The device according to claim 10, wherein:
the switching-determination module is integrated with the driving chip to form a single piece.

13. The device according to claim 10, wherein:
the switching-determination module is integrated with the processor to form a single piece.

14. The device according to claim 10, wherein the display device has a display region and a non-display region surrounding the display region, and the display panel includes:
a plurality of gate lines extending along a first direction and arranged in a second direction; and
a plurality of the data lines extending along the second direction and arranged in the first direction, wherein:
the plurality of gate lines intersects with the plurality of the data lines to define a plurality of sub-pixel units in the display region,
the plurality of sub-pixel units forms a plurality of pixel-unit rows, and
the driving chip provides the driving signals to each pixel-unit row through a corresponding gate line and provides the data signals to each pixel-unit row through a corresponding data line.

15. The device according to claim 14, further including a gate driving circuit, located in the non-display region and including a plurality of gate driving units, a first driving-signal line, and a second driving-signal line, wherein:
the plurality of gate driving units is electrically connected the plurality of gate lines in one-to-one correspondence;
the plurality of gate driving units includes a plurality of first gate driving units and a plurality of second driving units;
pixel-unit rows that are electrically connected to the plurality of first gate driving units and pixel-unit rows that are electrically connected to the plurality of second gate driving units are alternately arranged; and
each first gate driving unit of the plurality of first gate driving units is also electrically connected to the first driving-signal line, and each second gate driving unit of the plurality of second gate driving units is also electrically connected to the second driving-signal line, wherein:
the driving chip sequentially provides the driving signals to the plurality of pixel-unit rows through the first driving-signal line or the second driving-signal line, the plurality of gate driving units, and the plurality of gate lines.

16. The device according to claim 15, wherein:
odd rows of the plurality of pixel-unit rows are electrically connected to the plurality of first gate driving units; and
even rows of the plurality of pixel-unit rows are electrically connected to the plurality of second gate driving units.

17. The device according to claim 15, wherein:
the plurality of pixel-unit rows are divided into a plurality of pixel-unit-row groups with each group including two adjacent pixel-unit rows;
odd groups of the plurality of pixel-unit-row groups are electrically connected to the plurality of first gate driving units; and
even groups of the plurality of pixel-unit-row groups are electrically connected to the plurality of second gate driving units.

18. The device according to claim 10, wherein:
the interlaced scanning mode includes a one-row-interlaced scanning mode.

19. The device according to claim 18, wherein the one-row-interlaced scanning mode includes:
sequentially scanning odd rows of the plurality of pixel-unit rows;
after the odd rows are all scanned, sequentially scanning even rows of the plurality of pixel-unit rows; and
repeating the sequentially scanning the odd rows followed by the sequentially scanning the even rows, wherein:
when scanning the odd rows, the data signals applied to the odd rows have a same polarity;
when scanning the even rows, the data signals applied to the even rows have a same polarity; and
the polarity of the data signals applied to the odd rows is different from the polarity of the data signals applied to the even rows.

20. The device according to claim 10, wherein the progressive scanning mode includes:
sequentially scanning the plurality of pixel-unit rows from top to bottom or from bottom to top, wherein:
in a same frame, the data signals applied to the plurality of pixel-unit rows have a same polarity; and
in two consecutive frames, a polarity of the data signals applied to the plurality of pixel-unit rows in a former frame is different from a polarity of the data signals applied to the plurality of pixel-unit rows in a latter frame.
